(19) United States
(12) Patent Application Publication
(10) Pub. No.: US 2026/0211659 A1
(43) Pub. Date: Jul. 23, 2026

(54) ORCHESTRATION SYSTEM FOR UPDATING CONTAINERS WITH APPLICATIONS CONTAINED THEREIN, AND ORCHESTRATION METHOD BASED THEREON

(71) Applicant: Phoenix Contact GmbH & Co. KG, Blomberg (DE)

(72) Inventor: Uwe THOMAS, Oerlinghausen (DE)

(21) Appl. No.: 19/136,110

(22) PCT Filed: Dec. 7, 2023
(86) PCT No.: PCT/EP2023/084787

§ 371 Date: Jun. 5, 2025

(30) Foreign Application Priority Data
Dec. 12, 2022 (LU) LU 503173

(51) Int. Cl. G06F 8/65; G05B 19/042; G06F 8/61; G06F 9/455

(52) U.S. Cl. CPC G06F 8/65; G05B 19/0426; G06F 8/63; G06F 9/45558

(57) ABSTRACT

An orchestration system and method for updating containers with applications contained therein, which include a number of automation devices connected to an OT network of an automation plant, where each automation device of this number of automation devices is intended and configured to use to host and access at least one application contained within a container using a container runtime system. The orchestration system and method further include an updating device which is configured to effect an update of the containers and for this purpose is in communication with the runtime system of each automation device of this number of automation devices, wherein each automation device this number of automation devices furthermore accommodates a control device for controlling an automation of the automation device to be effected in the context of the automation plant, and a server unit which is in communication with the control device and is connected via a client/server interface to a client unit of the updating device.

### FIELD

The invention relates to an orchestration system with at least one automation device connected to an OT network of an automation plant, which is intended and configured, using a container runtime system to host and access at least one application contained within a container, as well as an orchestration method for updating applications contained in containers.

### BACKGROUND

It is well known that in the IT world today container technology (“information technology”) is quite widespread. For automation devices such as a PLC (programmable logic controller) or IO modules (input/output modules), frequency converters, robots, network devices, power supplies or other components used in automation technology, in particular network components in an plant, for which OPC UA (“Open Platform Communications Unified Architecture”; a standard for data exchange as a platform-independent, service-oriented architecture) is now an established standard for modelling and communication, this container technology, on the other hand, has not been an issue for so long, but is increasingly gaining acceptance in the automation market. If both technologies, i.e. OPC UA and container technology, are used in an automation device, this has so far been done independently of each other.

A major advantage of container technology is that within a runtime system, individual applications, in particular software programs, can be isolated from each other in containers and called up for processing, and available system resources, in particular hardware resources, can be allocated individually and flexibly for the efficient utilization of all resources. For isolated access and individual allocation, such systems usually include a so-called container engine, i.e. administration and management software specially designed for this purpose. The applications contained in the respective containers therefore generally only represent a small part of a larger application and are often referred to as microservices. As a result, many containers are often required to provide a large application in full, but these can be flexibly combined and managed using simple mechanisms, i.e. they can be orchestrated, which is another major advantage of container technology. As all of this is therefore also useful for the OT world (“operations technology”/automation technology), there are already individual automation devices that support container technology.

In EP 4064637 A1, for example, a way is proposed to facilitate the provision of such containers for the user by means of which information required for restarting and executing an application contained in a container can only be provided after installation of the container in a device intended and set up as an edge device for executing the application and does not have to be known at the time of development.

The internationally standardized ISA95 model, which divides automation into five levels, serves to differentiate between IT and OT in the context of the invention. The top two levels comprise the superordinate company level and the operations management level. The digital processes at these levels are assigned to IT and take place in IT networks set up for this purpose. The automation processes at the lower three levels, i.e. the process control level, the control level and the field level, are controlled via appropriately set up OT networks.

Pure container technology is therefore not ideal for automation technology. The advantages of container orchestrators in the IT world can also mean disadvantages in the OT world. In the OT world, deterministic behavior is required and automatic stopping/starting and updating prevents the safe operation of a machine or plant. Machines often cannot be stopped or restarted at random times. In addition, in the OT world, the firmware of the devices often has to be updated for cyber security, which often involves restarting the devices and is not supported by the container technology.

In EP 3 998 529 A1, a highly complex container orchestration system with a cluster of computing nodes for updating a plurality of control systems for controlling a plurality of operations of a plurality of OT devices is proposed for an industrial system to move operations between control systems and/or OT devices for the updating process within a runtime system so that certain control systems and/or OT devices can be updated while they are offline and other control systems and/or OT devices are kept online to perform the respective operations.

EP 4 064 045 A1 proposes a real-time update of process software with multiple software containers of a deployment unit provided on a single physical host node.

Here, a first software container is provided for executing a process application for controlling a process device, a second software container is provided as an execution manager for receiving an updated version of the process application and/or the first software container, and a third software container is provided, in which the updated version is initialized.

Subsequently, an application state of the first process application is then determined under the control of the execution manager, this is transferred from the first software container to the third software container, an update is then also executed using the received application state by means of the third software container and the first software container is then instructed to stop writing output signals for the process device and the third software container is instructed to write output signals for the process device.

### SUMMARY

The object of the invention is to demonstrate a new technical way by means of which, when updating industrial automation devices in an automation plant, such as programmable logic controllers, IO modules (input/output modules), frequency converters, robots, network devices, power supplies or other components used in automation technology, a respective automation process to be controlled can be integrated, in particular in order not to jeopardize safe operation of the automation plant as a whole by stopping and starting in the course of updates to be carried out.

The solution according to the invention is provided by a system with the features of claim 1 and a method according to claim 6. Useful embodiments of the invention are the subject of the dependent claims.

Useful and advantageous further developments are the subject of the respective dependent claims.

Accordingly, the invention proposes an orchestration system, in particular for updating containers with applications contained therein, comprising a number of automation devices connected to an OT network of an automation plant, wherein each automation device of said number of automation devices is intended and configured to host and access an application contained within a container using a container runtime system. Furthermore, the orchestration system according to the invention comprises a common update device which is set up to effect an update of the containers and which is in communication with the runtime system of each automation device of this number of automation devices for this purpose, and furthermore each automation device of this number of automation devices furthermore accommodates a control device for controlling in the context of the automation plant an automation of the automation device to be effected in each case, as well as a server unit, which is in communication with the control device and is additionally connected to a client unit of the updating device via a client/server interface.

By means of such an update device, which is not realized on a respective automation device itself, but as a common update device for all of the number of automation devices connected to the OT network of an automation plant encompassed by the orchestration system, the update of a plurality of containers with applications contained therein, which are hosted in the number of automation devices using a respective container runtime system, can on the one hand be effected in a coordinated manner, in particular also implement an update plan stored in the update device in a correspondingly coordinated manner. On the other hand, using the client unit set up in the updating device, the process control, i.e. in particular operating states and start and stop processes of a respective control device, can also be included in the coordination of the update to be carried out by via the server units additionally installed in all the automation devices accommodated. Consequently, it is possible in particular to wait for a point in time at which an update is possible without jeopardizing safe operation and/or to actively intervene in the control of automations to be effected in the context of the plant automation plant, for example in order to convert the process or the automation plant as a whole or even a sub-process or individual automation devices thereof to a safe operating state before an update is initiated and thus subsequently effected.

Furthermore, in such an orchestration system according to the invention, each server unit is preferably in communication with the operating system of the respective automation device, so that not only the updating of containers, but also the updating of firmware of the respective operating system can be coordinated and carried out safely, in particular according to an update plan stored in the update device.

Furthermore, setting up the server unit as an OPC-UA server, the client/server interface as an OPC-UA interface and the client unit as an OPC-UA client has proven to be particularly suitable for the orchestration system according to the invention.

Accordingly, the invention proposes an orchestration method for updating containers with applications contained therein hosted in a number of automation devices connected to an OT network of an automation plant for accessing them using a container runtime system, for which the runtime system of each automation device of this number of automation devices is set up in a communication link with a common updating device set up for effecting container updates and, for this purpose, a control device accommodated in each automation device of this number of automation devices for controlling an automation of the automation device to be effected in the context of the automation plant is set up in a communication link with a server unit additionally accommodated in each automation device of this number of automation devices and is connected via a client/server interface to a client unit of the common updating device.

According to the invention, in order to effect an update of containers with the applications contained therein in relation to at least each automation device of this number of automation devices involved in this process, a first update signal can thus be sent by the update device for the control device via the client/server interface to the server unit connected thereto before the update is initiated and forwarded by this to the control device, for stopping the automation to be effected, in particular by controlling the automation of the automation device to be effected in the context of the automation plant for assuming a safe state of the automation device or an area of the automation plant extending beyond the automation device, and after feedback to the updating device concerning the successful stopping of the automation to be effected, a second update signal is sent by the updating device to the runtime system to initiate the update.

### BRIEF DESCRIPTION OF THE DRAWING

The features and advantages of the invention already outlined above, as well as further features and advantages of the invention, will become more apparent from the following description by means of examples of preferred embodiments and further embodiments, reference being made to the accompanying drawings, in which:

FIG. 1 is a highly simplified overview of an exemplary orchestration system according to a preferred embodiment of the invention.

### DETAILED DESCRIPTION

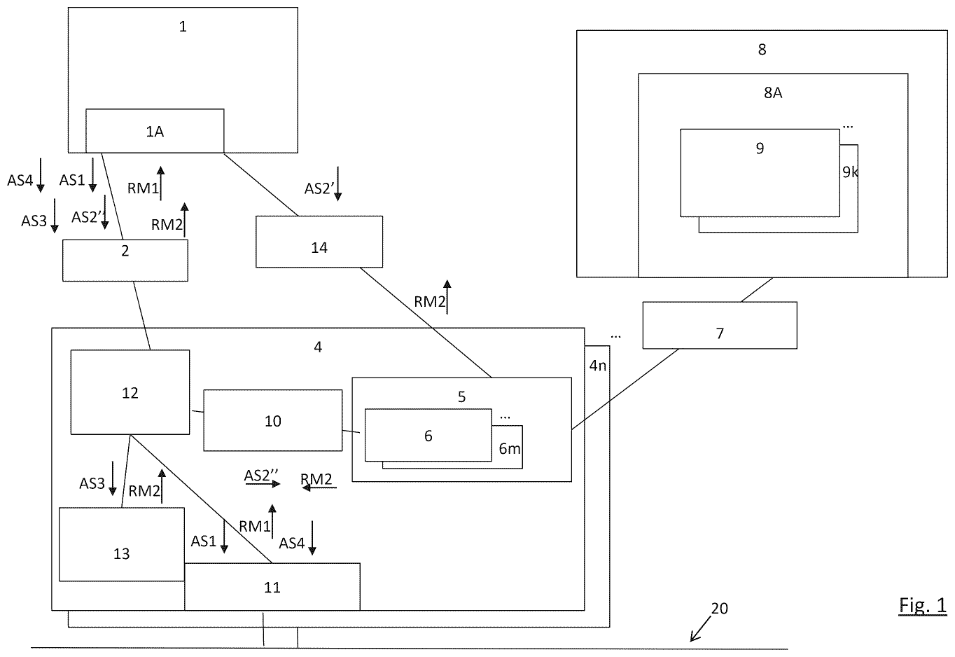

Reference is made below to FIG. 1, on the basis of which examples of preferred embodiments and further developments of an orchestration system according to the invention, in particular for updating containers with applications contained therein, and also orchestration methods based thereon are outlined and shown in a highly simplified form for reasons of clarity.

FIG. 1 shows a highly simplified overview of an orchestration system with a number of automation devices 4, 4n connected to an OT network 20 of an automation plant not shown in detail for reasons of clarity, whereby the automation device 4n is only partially shown. As symbolized by the dots to the right above the automation device, further automation devices can be connected in a preferred embodiment. The number of such automation devices comprised by the orchestration system is thus expediently not just one, but at least two, preferably a plurality exceeding this. Each automation device 4, 4n of this number of automation devices is, as indicated for automation device 4, intended and configured using a container runtime system 5 to host and access at least one application contained within a container 6, 6m. Since, as described at the beginning, many containers are often required in order to provide a large application in full, such automation devices 4, 4n, as indicated in the automation device 4, generally accommodate, in particular also application-related, several containers 6, 6m with applications contained therein for access, in particular in order to be able to be called up individually and efficiently for processing, using the container runtime system 5.

Furthermore, in addition to the number of automation devices 4, 4n, the orchestration system comprises an updating device 1, which is set up to effect an update of the containers 6, 6m and for this purpose is in communication with the runtime system 5 of each automation device 4, 4n of this number of automation devices, as described in more detail below. The container update is therefore initiated or coordinated from outside the automation devices and not by units hosted by the automation devices. The updating device 1 can in particular comprise a control and evaluation unit, in particular in the form of a microcontroller, and a memory device, which can be arranged externally and/or internally of the microcontroller and can comprise software, which can contain several programs, firmware and/or an operating system, whereby various protocols, in particular communication protocols, and/or control and evaluation routines can be implemented. An update schedule, for example, can also be stored in the memory.

However, each automation device 4, 4n accommodates a control device 11 for controlling an automation to be realized in the context of the automation plant and, within the scope of the invention, a server unit 12, which is both in communication with the control device 11 and connected to a client unit 1A of the updating device 1 via a client/server interface 2.

If an update of one container or also several containers is now to be carried out, which can be specified in particular manually by a user or also automatically, e.g. after certain time cycles and/or according to a stored update plan, or can also be specified to the updating device by other signaling, whereby the type of specification is, however, not the subject of the invention, the updating device 1 is appropriately set up to effect such an update of containers 6, 6m with the applications contained therein with respect to at least each automation device of this number of automation devices involved in this, i.e. in particular fundamentally affected in the context of this update, to send a first update signal AS1 from the updating device 1 for the respective control device 11 via the respective client/server interface 2 to the respective server unit 12 connected thereto before initiating the update, which is then forwarded by the latter to the control device 11, in order to stop the automation to be effected, i.e. in particular by controlling the automation of the automation device to be realized in the context of the automation plant in order to assume a safe state of the automation device or, in particular depending on the application, of an area of the automation system that extends beyond the automation device.

After feedback RM1 to the updating device 1, i.e. in particular from each automation device involved in this process, starting from the respective control device 11 to the respective server unit 12 connected thereto and from there via the respective client/server interface 2 to the updating device 1, regarding the stopping of the automation to be effected, a second update signal AS2 is then sent by the updating device 1 to the respective runtime system 5 to initiate the update.

As can be seen in FIG. 1, two different, complementary or alternative communication connections can be considered for establishing the communication links between the updating device 1 and each runtime system 5 within the scope of the invention.

On the one hand, the updating device 1, in particular the client unit 1A, can be connected to the runtime system 5 via a container interface 14. A second update signal AS2 sent via such an additional container interface 14 is marked AS2′ in FIG. 1.

On the other hand, also the server unit 12 can be connected to the runtime system 5 via a container management interface 10. A second update signal AS2 sent via this is marked AS2″ in FIG. 1.

The interfaces set up for each communication connection can comprise hardware and/or software for implementing respective communication protocols and transmitting the respective communication signals between the units involved, i.e. in particular between the updating device and runtime system, client unit and server unit, and server unit and runtime system, and can be set up wirelessly, e.g. via radio, or wired, e.g. via copper or fiber optics.

Here, the interfaces are appropriately set up so that, for example, the updating device can use them to query a container status, a container list including the currently running versions can be made available to the updating device 1, appropriately in response to its query, the updating of containers can be initiated, i.e. in particular can be initiated, containers to be updated can be stopped, i.e. in particular access to them can be prevented, and/or updated containers can be restarted, i.e. in particular access to them can be enabled again.

For the update itself, as is known per se, container images or memory images of the containers intended for an update can be provided on a server 8 serving as a source, e.g. a register server with a plurality of registers or memory areas 8A, the server 8 being in communication with the runtime system 5 for this purpose, in particular via a container register interface 7 set up accordingly as outlined in FIG. 1, in order to transfer corresponding container memory images 9 to it in response to an initiated container update. In addition, or as an alternative to this, it can also be provided that such images can be made available in a memory area of the updating device 1 itself and transferred from there to the respective automation devices 4, 4n to the runtime systems 5, whereby in the alternative case no separate server 8 serving as a source is required.

In a preferred embodiment, the updating device 1, in order to effect the update, consequently also transmits at least one version designation of a new memory image 9 of at least one container to be updated to the corresponding runtime system 5, in particular as part of the update signal AS2 or by means of a separate communication signal provided for this purpose but not shown in the figure for reasons of clarity, initiates at least the transmission of the new container memory image 9 of each of the at least one container to be updated to the corresponding runtime system 5, and stops the execution of each of the at least one container 6 to be updated. Depending on the implementation, the update signal AS2 itself may also comprise corresponding signal components for initiation and stopping, or at least one further communication signal may also be provided, although this is not shown in the figure for reasons of clarity

The same applies to a preferred starting of the at least one container 6 updated with a new memory image by the updating device 1 after the update has been effected, i.e. in particular after corresponding feedback from the runtime system 5 to the updating device.

As further outlined in FIG. 1, in a preferred embodiment of the invention, each server unit is additionally in communication with the operating system 13 of the respective automation device. Consequently, the updating device 1 connected jointly to the automation devices 4, 4n according to the invention can preferably be used not only to effect an orderly update of containers, but also a desired or even necessary update of the firmware of the respective operating system. In particular, since, as mentioned at the beginning, OPC UA is an established standard for modelling and communication in automation technology and, as is known, the update of device firmware can already be controlled via this, it has been shown to be particularly suitable for the orchestration system according to the invention to set up the server unit 12 as an OPC UA server, the client/server interface 2 as an OPC UA interface and the client unit 1A as an OPC UA client. OPC UA and container technology are thus utilized jointly or in a complementary manner in a particularly expedient implementation of the present invention

After the aforementioned feedback RM1 to the updating device 1 concerning the successful stopping of the automation to be effected, a third update signal AS3 can thus also be sent, for example, from the updating device 1 via the client/server interface 2 to the server unit 12 of at least one of the automation devices 4, 4n connected to the OT network in order to effect an update of its operating system firmware.

Consequently, a fourth update signal AS4 can be sent by the update device 1 for the control device 11 via the client/server interface 2 to the server unit 12 connected thereto and forwarded by the latter to the control device 11 for restarting the automation to be effected, but expediently only after feedback RM2 regarding the complete success of all updates to be effected, in accordance with the preferred further development.

Consequently, by means of the client unit 1A set up in the updating device 1 not only the process control, i.e. in particular operating states and start and stop processes of a respective control device 11, can be additionally included via the server units 12 additionally accommodated in all the automation devices 4, 4n, in the coordination of the container update to be effected, but preferably also a firmware update can be included in the updating process.

Summarizing the above description, a possible process using an orchestration system according to the invention can be outlined in brief, for example as follows.

A list of the containers including the currently running versions is made available to the update device 1, in particular either via the client/server interface 2 and container management interface 10 or via the container interface 14, depending on the realization.

If an update is now to be carried out, the update device 1 stops the machine/plant via the client/server interface 2 and then also stops the container 6 to be updated either via the client/server interface 2 and container management interface 10 or via the container interface 14, depending on the realization.

Depending on the implementation, before or only after this stop, the version designation of a new container image 9 is transferred from the update device 1, in particular from the client unit 1A, to the runtime system 5 of the corresponding automation device 4, 4n and the transfer of the new image 9 from the memory area 8A of the server 8 to the runtime system 5 of the corresponding automation device 4, 4n is initiated. Depending on the realization, this can be done either via the client/server interface 2 and container management interface 10 or via the container interface 14. As previously mentioned, it can also be provided, as a supplement or alternative, that such images 9 can be provided in a memory area of the updating device 1 itself and transferred from there to the respective automation devices 4, 4n to the runtime systems 5, whereby in the alternative case no separate server 8 serving as a source is required.

The updating device 1 starts the container 6 with the new image 9, i.e. either via the client/server interface 2 and container management interface 10 or via the container interface 14, depending on the realization. Of course, several containers 6, 6m, even in several automation devices 4, 4n, can also be updated accordingly.

The machine/plant starts automatically or is started explicitly by the update device 1 via the client/server interface 2.

In addition, the update device 1 can also perform a firmware update for the operating system 13 of one or more automation devices 4, 4n, e.g. a firmware update necessary for a container to be updated or already updated, expediently via OPC UA mechanisms already known per se, before new, i.e. updated containers are started.

It is also apparent from the above description that the method according to the invention is given in particular by a combination of suitable hardware and software, whereby the necessary software can also run, for example, on existing hardware, such as an existing processor. However, according to a reasonable appreciation of the above description, program-specific implementation, in particular also the program-specific setup of the devices and interfaces involved in the context of the invention, is within the knowledge and ability of a programmer commissioned with this.

1. An orchestration system, for updating containers with applications contained therein, comprising:
a number of automation devices connected to an OT network of an automation plant, wherein each automation device of this number of automation devices being intended and set up, using a container runtime system to host and access at least one application contained within a container, and
an updating device which is set up to effect an update of the containers and for this purpose is in communication with the runtime system of each automation device of this number of automation devices,
wherein each automation device of this number of automation devices further accommodates a control device for controlling an automation of the automation device to be effected in the context of the of the automation plant, and a server unit which is in communication with the control device and is connected to a client unit of the updating device via a client/server interface.

2. The orchestration system according to claim 1, wherein each server unit is further in communication with the operating system of the respective automation device.

3. The orchestration system according to claim 1 or 2, wherein the server unit is set up as an OPC-UA server, the client/server interface as an OPC-UA interface and the client unit as an OPC-UA client.

4. The orchestration system according to claim 1, wherein for establishing the communication link between the updating device and each runtime system;
the server unit is connected to the respective runtime system via a container management interface which is set up for a communication link between the updating device and the respective runtime system, for providing a list of the containers including the currently running versions, for querying the container status, for initiating the updating of containers, for stopping containers to be updated and/or for starting updated containers, and/or
the updating device is connected to the respective runtime system via a container interface which is set up for a communication link between the updating device and the respective runtime system, for providing a list of the containers including the currently running versions, for querying the container status, for initiating the updating of containers, for stopping containers to be updated and/or for starting updated containers.

5. The orchestration system according to claim 1, further comprising at least one server in communication with the respective runtime system for providing container memory images.

6. An orchestration method for updating containers with applications contained therein, which are hosted in a number of automation devices connected to an OT network of an automation plant for accessing them using a container runtime system comprising:
an updating device is set up for effecting an update of containers with applications contained therein and hosted in this number of at least one automation device and is set up in a communication link with the runtime system of each automation device of this number of automation devices,
in each automation device of this number of at least one automation device a control device for controlling an automation of the automation device to be realized in the context of the automation plant and a server unit which is set up in a communication link with the control device and is connected to a client unit of the updating device via a client/server interface are furthermore hosted,
that in order to effect an update:
with regard to at least each automation device of this number of automation devices involved and before initiating the update, a first update signal is sent from the updating device for the control device via the client/server interface to the server unit connected thereto and is forwarded by the latter to the control device specifically for stopping the automation to be effected, by controlling the automation of the automation device to be effected in the context of the automation plant for assuming a safe state of at least the automation device or of an area of the automation system extending beyond the automation device
and in that, after feedback to the updating device concerning the successful stopping of the automation to be effected, a second update signal is sent by the updating device to the runtime system to initiate the update.

7. The orchestration method according to claim 6, wherein the updating apparatus for effecting the updating further comprises:
transmitting a version designation of a new memory image of at least one container to be updated to the corresponding runtime system
initiating the transfer of the new container memory image of each of the at least one container to be updated to the corresponding runtime system and
stopping the execution of each of the at least one container to be updated.

8. The orchestration method according to claim 7, wherein the updating device further starts the at least one container updated with new memory image after effecting the update.

9. The orchestration method according to claim 6, wherein after feedback to the updating device concerning the successful stopping of the automation to be effected, a third update signal is sent from the updating device via the client/server interface to the server unit of at least one of the automation devices connected to the OT network for effecting an update of firmware of its operating system.

10. The orchestration method according to claim 6, wherein after feedback concerning the complete success of all updates to be effected, a fourth update signal is sent from the update device for the control device via the client/server interface to the server unit connected thereto and is forwarded by the latter to the control device for restarting the automation to be effected.
